(19) United States
(12) Patent Application Publication
(10) Pub. No.: US 2006/0097214 A1
(43) Pub. Date: May 11, 2006

(54) Metering ball valve and method of determining fluid flow therethrough

(76) Inventor: Peter J. Rebello, Huntington Beach, CA (US)

Correspondence Address: MYERS DAWES ANDRAS & SHERMAN, LLP, 19900 MACARTHUR BLVD.,, SUITE 1150, IRVINE, CA, 92612, US

(21) Appl. No.: 11/314,632

(22) Filed: Dec. 21, 2005

Related U.S. Application Data
(62) Division of application No. 10/732,974, filed on Dec. 11, 2003, now abandoned.

(51) Int. Cl. F16K 5/06

(52) U.S. Cl. 251/315.14

(57) ABSTRACT

A metering ball valve has a slot and a flow channel design such that flow varies in a linear manner as the valve is operated over the range from open to shut. Reasonably accurate volumetric flow rate determination is achieved based on valve position indication on the valve itself. In an alternative embodiment, the ball valve has an array of orifices that replace the slot. A method is disclosed to determine flow rate based on valve position indication.

### BACKGROUND OF THE INVENTION

1. Field of the Invention

The present invention relates generally to throttle valves that are capable of regulating system fluid flow. More particularly, the present invention relates to a ball valve designed to operate in a range of intermediate positions from open to shut wherein the volumetric fluid flow rate can be determined based on valve position and known system parameters.

2. Description of the Prior Art and Related Information

Ball valves for the control of fluid flow are well known in various applications. These valves generally benefit from characteristics such as low torque required to operate, low pressure drop and quick opening or shut-off. Further, the valves generally contain a spherical ball with a flow channel extending therethrough that allows fluid flow through the valve when the valve is open. The valve is shut by rotating the ball a quarter-turn (or less), thus blocking the flow channel and forming a seal between the housing and the surface of the ball.

Also known are flowmeters that operate by sensing the pressure differential or headloss across a flow restriction. Based on Bernoulli's law and known parameters, the flow rate is determined from a pressure differential. Examples of this type of flow meters include an orifice plate flowmeter and venturitubes. In the case of measuring the flow rate across a valve, the valve itself can be the flow restriction device where flow rate is reduced enough to create an accurate pressure differential measurement.

U.S. Pat. No. Re. 33,649 entitled Butterfly Valve Having A Function for Measuring A Flow Rate And Method of Measuring A Flow Rate with A Butterfly Valve, issued to Kawai, discloses a butterfly valve having throttling and metering capability. Kawai also discloses the use of differential pressure across the butterfly valve and known system parameters to determine flow rate. Kawai ultimately derives a method of determining flow rate across a butterfly valve as a function of the torque applied to the valve stem as a result of the force applied by the fluid across the valve seat. One drawback of the device and method disclosed by Kawai, is that it uses complicated means to measure torque and valve position. Also, the method is not applicable to all types of valves and Kawai is specifically not applicable to ball valves.

Also known in the art are other types of throttle valves. Globe type valves, for example, are generally either fully open or fully shut to provide on-off flow control. However, globe type valves can be modified to operate in the partially open position to regulate system flow. The basic difference is in the valve disc. The throttle valve disc differs in that it has an elongated lower section, generally in the shape of a cone. For all throttle valves, it is desired to provide laminar fluid flow across the valve so that flow varies in a linear manner as the valve is operated over the range from open to shut.

Current ball valves, even those used for throttling or metering, contain a circular orifice. In an intermediate position, the amount of the orifice that is unobstructed with respect to the valve body will be proportional to the volumetric flow rate. In metering applications, it is desired that the fluid flow vary linearly through the intermediate positions. In this case, the geometric shape of a circular orifice will not yield a design that vary flow rate linearly.

Based on the foregoing discussion, what is needed in the art is a relatively uncomplicated method of metering a throttle valve based on valve position. Also, a need exists to provide a throttle valve design particular to ball valves that provides for laminar flow across the valve opening. Further, a ball valve design is needed that varies fluid flow in a linear manner over the range from open to shut.

Therefore, it is an object of the present invention to provide a ball valve design, capable of throttling and regulating system flow, such that flow varies in a linear manner as the valve is operated over the range of intermediate positions from open to shut. It is further an object of the present invention to provide a method of metering a valve that is reasonably accurate and is based on valve position and known system parameters. Yet still it is another object of the present invention to provide a metering ball valve that is simple to use, relatively easy to manufacture and comparatively cost effective.

### BRIEF SUMMARY OF THE INVENTION

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112.

The present invention specifically addresses and alleviates the above-mentioned deficiencies associated with the prior art. More particularly, the present invention comprises a ball valve for controlling fluid flow comprising: a body, an inlet port and an outlet port, a ball within the body having a generally cylindrical passage therethrough, the cylindrical passage having a size proportional to volumetric fluid flow rate for fluid communication between said inlet port and said outlet port. The ball in this embodiment further includes a first opening in the cylindrical passage; and the first opening is generally circular in shape and has a size generally equal to the size of the cylindrical passage. The invention further comprises a second opening in the cylindrical passage defined by an inner and an outer wall of said ball, the second opening smaller in size than said first opening, said inner wall having a generally curved shaped to reduce friction of fluid flow therethrough.

The valve of the present invention further has a valve stem having a position proportional to fluid flow rate through the valve. The valve stem is connected to the ball for rotating the ball to control the fluid flow rate through the valve, wherein the valve stem proportional to the fluid flow rate can be read by a user thereof.

In a preferred embodiment of the present invention, the second opening in the flow channel is a slot. Alternatively, the slot can be replaced by an array of orifices arranged in a horizontal plane, perpendicular to an axis of rotation of the ball. The ball or rotational element can alternatively be spherical or cylindrical in shape. The ball valve of the present invention further comprises a valve position indicator connected to the valve stem. Yet still the invention comprises a means for determining a magnitude of the fluid flow rate through the valve based on the valve stem position. A handle connected to the valve stem is used for positioning the valve between an open position, a shut position, and a plurality of intermediate positions.

The ball valve of the present invention also has an open stop for preventing the stem from rotating past the open position and for securing the stem in the open position. A closed stop is similarly provided for preventing the stem from rotating past the closed position.

The present invention can additionally be characterized as a ball having a cylindrical flow passage about an axis, the ball used to control fluid communication in a ball valve comprising a first opening in the flow passage defined by removing a cross section of the ball perpendicular to said axis of said cylindrical flow passage; and a second opening smaller in size than the first opening and defined by an inner and outer wall of the ball. The second opening of the ball can similarly be in the shape of a slot or an orifice. The ball also comprises a notch carved out of the ball, suitable to engage a valve stem.

The present invention can also be characterized as a method of metering a throttle valve between an inlet port and an outlet port based on valve position, the method comprising: providing a throttle valve such that flow varies in a linear manner as the valve is operated over a range from open to shut; determining a flow rate through the valve when the valve is fully open; throttling the valve and reducing flow through a plurality of intermediate positions; determining a flow rate in the plurality of intermediate positions; and recording the flow rate corresponding to when the valve is fully open and each intermediate valve position so a valve operator could determine the flow rate based on valve position. The method metering a valve further comprises providing position indication and volumetric flow rate determination on the valve.

These, as well as other advantages of the present invention, will be more apparent from the following description and drawings. It is understood that changes in the specific structure shown and described may be made within the scope of the claims, without departing from the spirit of the invention.

### BRIEF DESCRIPTION OF THE DRAWINGS

The invention can be better visualized by turning now to the following drawings wherein like elements are referenced by like numerals.

FIG. 1 is an exploded isometric view of a ball valve of the present invention illustrating individual components;

FIG. 2 is a side view of a ball valve embodiment of the present invention;

FIG. 3 is a top view of a ball valve embodiment of the present invention;

FIG. 4 is a cross sectional view of a ball valve embodiment taken along sectional line 4-4 of FIG. 3;

FIG. 5 is a cross sectional view of a ball valve of the present invention taken along sectional line 5-5 of FIG. 2 illustrating the flow channel of the ball valve in an open position;

FIG. 6 is a cross sectional view of a ball valve of the present invention taken along sectional line 5-5 of FIG. 2 illustrating the flow channel of the ball valve in an intermediate position;

FIG. 7 is a cross sectional view of a ball valve of the present invention taken along sectional line 5-5 of FIG. 2 illustrating the flow channel of the ball valve in a shut position;

FIG. 8a is a an end view of a ball valve of the present invention taken along line 8-8 of FIG. 4; and

FIG. 8b is an end view of a ball valve of the present invention taken along line 8-8 of FIG. 4.

FIG. 9 is a perspective view of a ball of an alternative embodiment of the present invention.

### DETAILED DESCRIPTION OF THE PREFERRED EMBODIMENTS

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

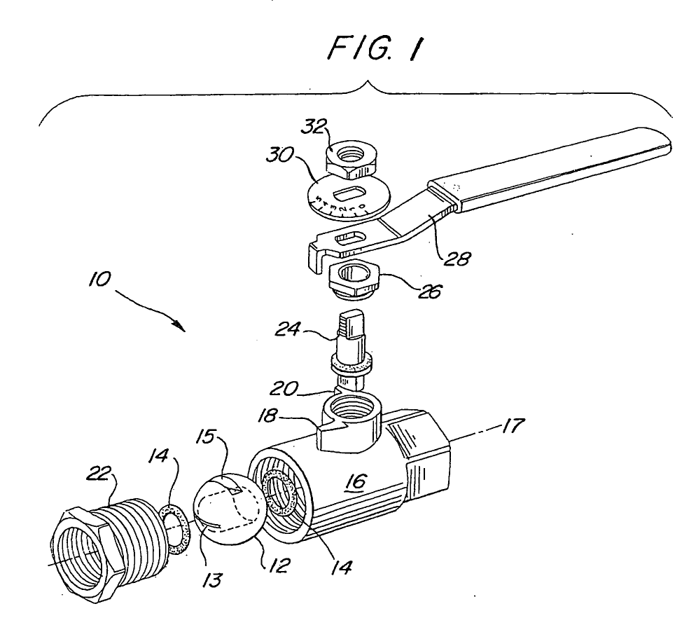

Referring initially to FIG. 1, an exploded isometric view of a ball valve 10 of the present invention illustrating individual components is shown. Valve body 16 houses sealing rings 14 on opposing sides of ball 12. This structure 10 is further secured by ball retaining fitting 22, which also defines outlet port 48 (FIG. 4). Body 16, sealing rings 14, ball 12, and retaining fitting 22 are all assembled about axis 17. The ball 12 of the present invention has a cylindrical passage 42 (FIG. 4) that serves as a flow channel and is illustrated by a dashed line in FIG. 1. The ball 12 has a stem engagement notch 15 used to secure stem 24 to ball 12. Stem 24 is further secured by stem lock nut 26 to body 16 in a threaded connection. Stem 24 additionally has a sealing ring to prevent fluid leakage past stem 24. Stem 24 additionally has a male extension adapted to fit through valve operating handle 28 and valve position indication 30. Stem 24 is then finally secured again by the handle and plate lock nut 32.

It is important to note that the invention herein is applicable to throttle valves and all types of ball valves 10 independent of the material of the ball 13 that may be, for example, metal or plastic. Also, the present invention is applicable to valves containing a cylindrical rotational element that could replace the spherical ball 13.

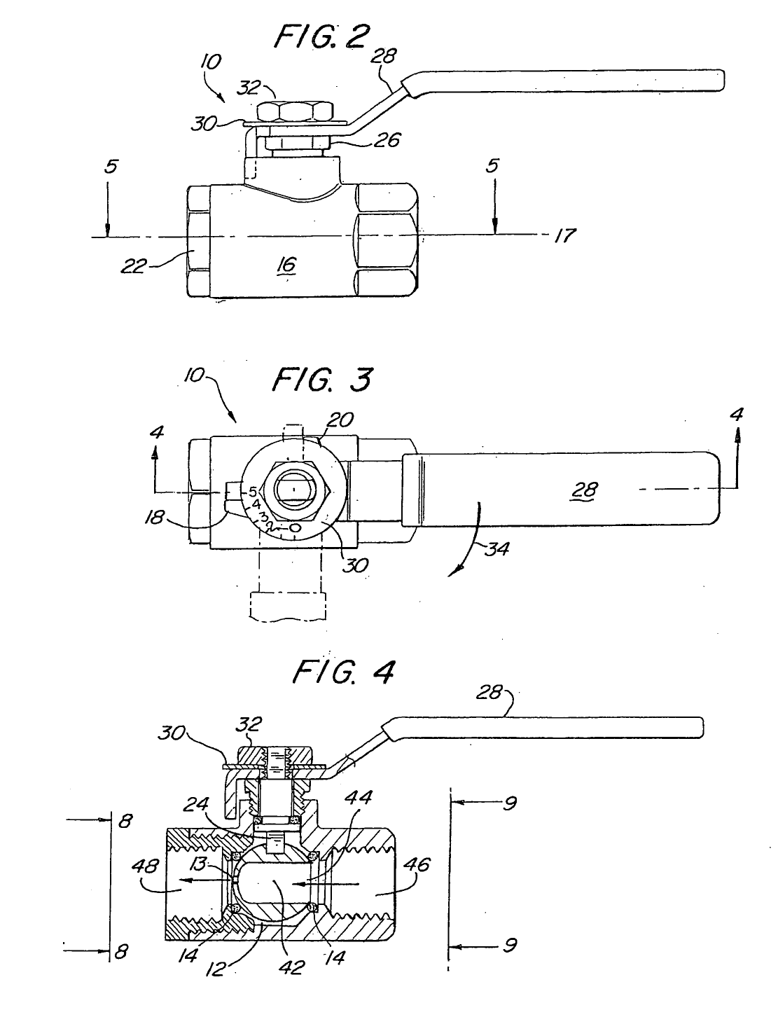

While FIG. 1 illustrates the construction of a preferred embodiment of the present invention, FIG. 2 and FIG. 3 show an assembled valve 10 of FIG. 1. In FIG. 2, valve operating handle 28 is shown parallel to the direction of flow and axis 17, as typical for ball valves in the open position. Ball retaining fitting 22, is shown secured to body 16. Similarly, handle and plate lock nut 32 is shown securing the handle 28 and valve position plate 30 to the valve body 16.

FIG. 3 illustrates a top view of ball valve 10 of the present invention. Valve operating handle 28 is secured against open stop 18. This prevents the cylindrical passage 42, as shown in FIG. 4, from being rotated past the open position. To close the valve 10, handle 28 is rotated along the direction shown by arrow 34. Valve position indication plate 30 is shown with hash marks, 0 through 5, that indicate valve position. Position 5, for example, corresponds to the open position while position 0 corresponds to the shut position. Positions 1 through 4 are intermediate positions for controlling the amount of fluid flow through the valve 10.

FIG. 4 illustrates a cross sectional view of a valve 10 of the present invention taken along sectional line 4-4 of FIG. 3. Ball 12 can be seen engaged by stem 24 via a notch arrangement. Inlet and outlet ports 46, 48 are illustrated as having threaded walls. However, it is understood that external piping (not shown) would have outer walls to engage the threads of inlet and outlet ports 46, 48. Importantly, the inside walls of any external piping are smooth to provide laminar flow therethrough. Laminar flow, with minimal mixing that would occur under turbulent flow conditions, is preferred to more closely provide a linear relationship between valve position and volumetric fluid flow rate through the valve 10. First opening 44 of cylindrical passage 42 is shown as a circular opening; and now referring back to FIG. 1, can be characterized as planar section taken out of spherical ball 12 to define an opening size that is generally the same diameter as the cylindrical passage 42. It is important to note that for flow to vary linearly, or as designed, then first opening 44 of cylindrical passage 42 must have greater cross-sectional area than slot 13, or orifices 92 (FIG. 9).

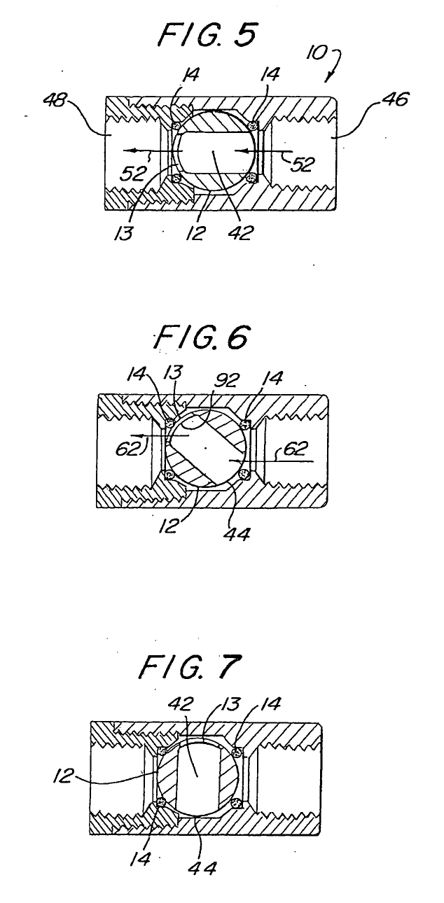

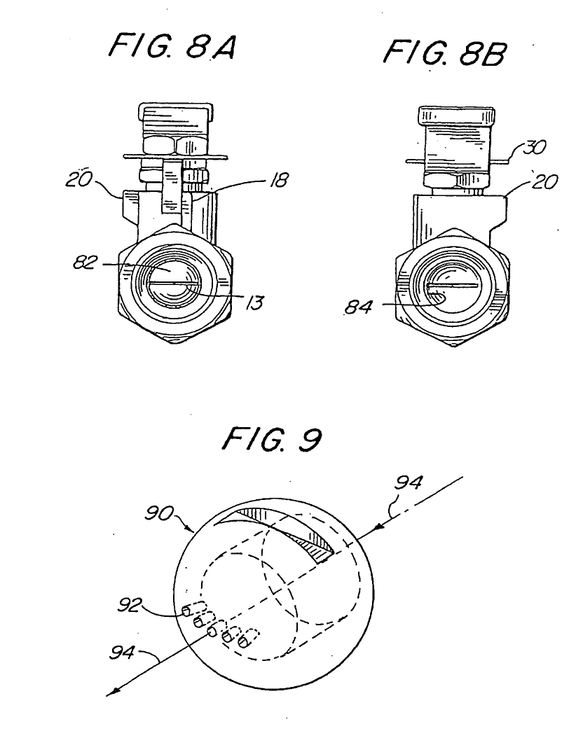

Referring now to FIG. 5, a top cross sectional view of valve 10 in the open position is illustrated. Arrows 52 indicate the flow direction. As the valve 10 is throttled down, in this example by rotating ball 12 clockwise as illustrated by FIG. 6, slot 13 is partially blocked to reduce fluid flow. Second opening slot 13 is defined by an inside wall 84 (FIG. 8b) that is curved. This curved, partially spherical inside wall 84 facilitates laminar flow and the desired linear relationship between valve position and fluid flow rate by making friction loss uniform. Additionally, the partially spherical inner wall 84 reduces the friction of fluid flow through slot 13. Employing a slot 13 as the second opening will ensure that proportional amounts of the second opening 13 are obstructed as the valve is shut through its intermediate positions. Conversely, if the second opening were circular, different proportional amounts of the second opening would be obstructed as the valve 10 is cycled through intermediate positions that would not provide the linear relationship desired. Arrow 62 illustrates the direction of flow through the valve 10. It is further envisioned that the valve position indication could contain an actual volumetric fluid flow rate based on known system parameters or empirical data as previously discussed herein.

FIG. 7 shows a top cross sectional view of valve 10 of the present invention in the shut position. Cylindrical passage 42 is blocked and sealing rings 14 can be seen preventing leakage past ball 12. FIGS. 8a and 8b are end views of the valve 10 of the present invention. FIG. 8a provides another illustration of open stop 18 and closed stop 20. Outer wall 82 of ball 12 is spherical in shape.

FIG. 9 illustrates an example of an alternate ball 90 embodiment of the present invention. In order for flow rate to vary approximately linearly, the ball 90 has more than one orifice 92 arranged in a horizontal plane perpendicular to the axis of rotation 94 of the valve. This design provides a discrete step increase in fluid flow based on the rotational position of the ball 90 that approximates a linear relationship between fluid flow and valve position. Still, fluid flow is metered since valve position will correspond to the number of orifices unblocked in the flow channel. Fluid flow characteristics can be designed non-linearly by employing a ball having varying cross-sectional sizes of orifices or varying the spacing along the horizontal plane.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

Thus, the detailed description set forth herein in connection with the appended drawings is intended as a description of the presently preferred embodiment(s) of the invention and is not intended to represent the only form(s) in which the present invention may be constructed or utilized. The description sets forth the functions and the sequence of steps for constructing and operating the invention in connection with the illustrated embodiment(s). It is to be understood, however, that the same or equivalent functions may be accomplished by different embodiments that are also intended to be encompassed within the spirit of the invention.

Modifications and additions may be obvious to those skilled in the art and may be implemented to adapt the present invention for use in a variety of different applications.

1. A ball valve for controlling fluid flow comprising:
a body;
an inlet port and an outlet port;
a ball within said body having a generally cylindrical passage therethrough, the cylindrical passage having a size proportional to volumetric fluid flow rate for fluid communication between said inlet port and said outlet port, the ball further including:
a first opening in the cylindrical passage, said first opening generally circular in shape having a size generally equal to said size of said cylindrical passage; and
a second opening in said cylindrical passage defined by an inner and an outer wall of said ball, the second opening smaller in size than said first opening, said inner wall having a generally curved shaped to reduce friction of fluid flow therethrough, wherein the second opening comprises a plurality of orifices; and
a valve stem having a position proportional to fluid flow rate through the valve, the valve stem connected to said ball for rotating said ball to expose a discrete number of the orifices to the outlet port so as to control the fluid flow rate through the valve, wherein the valve stem proportional to the fluid flow rate can be read by a user thereof.

2. (canceled)

3. The ball valve of claim 1, further comprising a means for determining a magnitude of said fluid flow rate through the valve based on said valve stem position.

4. The ball valve of claim 1, further comprising a valve position indicator connected to the valve stem.

5. The ball valve of claim 4, wherein said valve position indicator comprises hash marks to identify valve position.

6. The ball valve of claim 1, wherein said inner wall has a partially spherical shape.

7. The ball valve of claim 1, further comprising sealing rings on opposing sides of said ball to prevent leakage past said ball when the ball valve is in a shut position.

8. The ball valve of claim 1, further comprising a stem lock nut to secure said valve stem to said body.

9. The ball valve of claim 1, further comprising a ball retaining fitting to secure said ball in said body.

10. The ball valve of claim 1, further comprising a handle connected to said valve stem for positioning the valve between an open position, the shut position, and a plurality of intermediate positions.

11. The ball valve of claim 10, further comprising:
an open stop for preventing the stem from rotating past the open position and for securing the stem in the open position; and
a closed stop for preventing the stem from rotating past the closed position.

12. The ball valve of claim 10, further comprising a handle and plate lock nut to secure said handle to said valve stem.

13. A rotational element in a valve, having a cylindrical flow passage about an axis, the rotational element used to control fluid communication in a ball valve comprising:
a first opening in the flow passage defined by removing a cross section of the rotational element perpendicular to said axis of said cylindrical flow passage; and
a second opening in the flow passage smaller in size than the first opening and defined by an inner and outer wall of the rotational element, wherein said inner wall of said rotational element comprises a curved shape, wherein the second opening comprises a Plurality of orifices.

14. (canceled)

15. (canceled)

16. The rotational element of claim 13, wherein said rotational element is spherical in shape.

17. The rotational element of claim 13, wherein said rotational element is cylindrical in shape.

18. The rotational element of claim 13, wherein said rotational element is made from plastic material.

19. The rotational element of claim 13, wherein said rotational element is made from metal material.

20. The rotational element of claim 13 further comprising a notch carved out of said rotational element, suitable to engage a valve stem.

21. A method of metering a throttle valve between an inlet port and an outlet port based on valve position, the method comprising:
providing a throttle valve with a plurality of orifices such that flow varies as the valve is operated over a range from open to shut;
determining a flow rate through the valve when the valve is fully open;
throttling the valve and reducing flow through a plurality of intermediate positions so as to block one or more of the plurality of orifices;
determining a flow rate in the plurality of intermediate positions; and
recording the flow rate corresponding to when the valve is fully open and each intermediate valve position so a valve operator could determine the flow rate based on valve position.

22. The method of metering a valve of claim 21, further comprising providing position indication on the valve.

23. The method of metering a valve of claim 22, further comprising providing volumetric flow rate determination on the valve.

24. The ball valve of claim 1, wherein the fluid flow rate through the valve is proportional to a total area of the number of orifices exposed to the outlet port.

25. The rotational element of claim 13, wherein each orifice is circular.

26. The rotational element of claim 13, wherein each orifice is non-circular.

27. The rotational element of claim 13, wherein the plurality of orifices comprises:
a first orifice having a first cross-sectional size; and
a second orifice having a second cross-sectional size that is different that the first cross-sectional size.
